(19) United States
(12) Patent Application Publication
(10) Pub. No.: US 2005/0091039 A1
(43) Pub. Date: Apr. 28, 2005

(54) Enhanced foreign language dictionaries

(76) Inventor: Bilal S. Simab, Concord, CA (US)

Correspondence Address: ERIC K SATERMO;REGISTERED PATENT AGENT, P.O. BOX 19099, IRVINE, CA, 92623, US

(21) Appl. No.: 10/692,925

(22) Filed: Oct. 25, 2003

(51) Int. Cl. G06F 17/21

(52) U.S. Cl. 704/10

(57) ABSTRACT

A foreign language dictionary provides Language 1-to-Language 1 functionality, Language 1-to-Language 2 functionality, and Language 2-to-Language 2 functionality. The dictionary may include a plurality of entries each having a first language section and a second language section. For example, the first language section may be in English, while the second language section may be in Spanish. The first language section of each entry may include a target word in the first language and a definition of the target word, thereby providing an English-to-English dictionary. The second language section may include a phonetic of the target word of the first language and a translation of the target word in the second language, thereby providing an English-to-Spanish dictionary. In addition, the second language section may include a definition of the translation in the second language, thereby providing a Spanish-to-Spanish dictionary.

### BACKGROUND OF THE INVENTION

The present invention relates dictionaries, particularly foreign language dictionaries.

Conventional foreign language dictionaries, such as an English-Spanish dictionary, typically include two sections: an English-to-Spanish section with the respective Spanish translations of a number of English entries, and a Spanish-to-English section with the respective English translations of a number of Spanish entries.

Conventional foreign language dictionaries are deficient in that the entries only provide a translation of a target word. For example, if a user looks up the word casa in a Spanish-to-English dictionary, then the entry typically provides the English translation, i.e., house. Conversely, if the user looks up house in an English-to-Spanish dictionary, then the entry provides the Spanish translation, i.e., casa. If a more extensive study were desired by learning the Spanish definition of casa, then the user would need to look up this word in a conventional Spanish dictionary. Similarly, if a more extensive study were desired by learning the English definition of house, then the user would need to look up this word in a conventional English dictionary. Accordingly, three separate dictionaries would need to be utilized to an extensive study of a particular word and its counterpart in a foreign language.

### BRIEF SUMMARY OF THE INVENTION

According to some of the embodiments, a foreign language dictionary may include a plurality of entries each having a first language section and a second language section. For example, the first language section may be in English, while the second language section may be in Dari (a language of Afghanistan). The first language section of each entry may include a target word in the first language and a definition of the target word, thereby providing an English-to-English dictionary. The second language section may include a phonetic of the target word of the first language and a translation of the target word in the second language, thereby providing an English-to-Dari dictionary. In addition, the second language section may include a definition of the translation in the second language, thereby providing a Dari-to-Dari dictionary.

Other features and advantages of the present invention will become apparent to those skilled in the art from a consideration of the following detailed description taken in conjunction with the accompanying drawings.

### BRIEF DESCRIPTION OF THE SEVERAL VIEWS OF THE DRAWINGS

FIG. 1 is a block diagram of a dictionary;

FIG. 2 illustrates a plurality of entries of a dictionary;

FIG. 3 illustrates an example of an entry with a left-to-right Roman language and a right-to-left non-Roman language (i.e., English and Dari);

FIG. 4 illustrates an example of an entry with two Roman languages (i.e., English and Spanish);

FIG. 5 illustrates another example of an entry with a left-to-right Roman language and a right-to-left non-Roman language (i.e., English and Mandarin);

FIG. 6 illustrates an entry for a dictionary according to a number of embodiments;

FIG. 7 illustrates an entry for a dictionary according to other embodiments;

FIG. 8 illustrates an entry for a dictionary according to still other embodiments;

FIG. 9 illustrates a dictionary in the form of a book;

FIG. 10 illustrates an electronic dictionary; and

FIG. 11 illustrates embodiments in which a dictionary may be a software dictionary or an online dictionary.

### DETAILED DESCRIPTION OF THE INVENTION

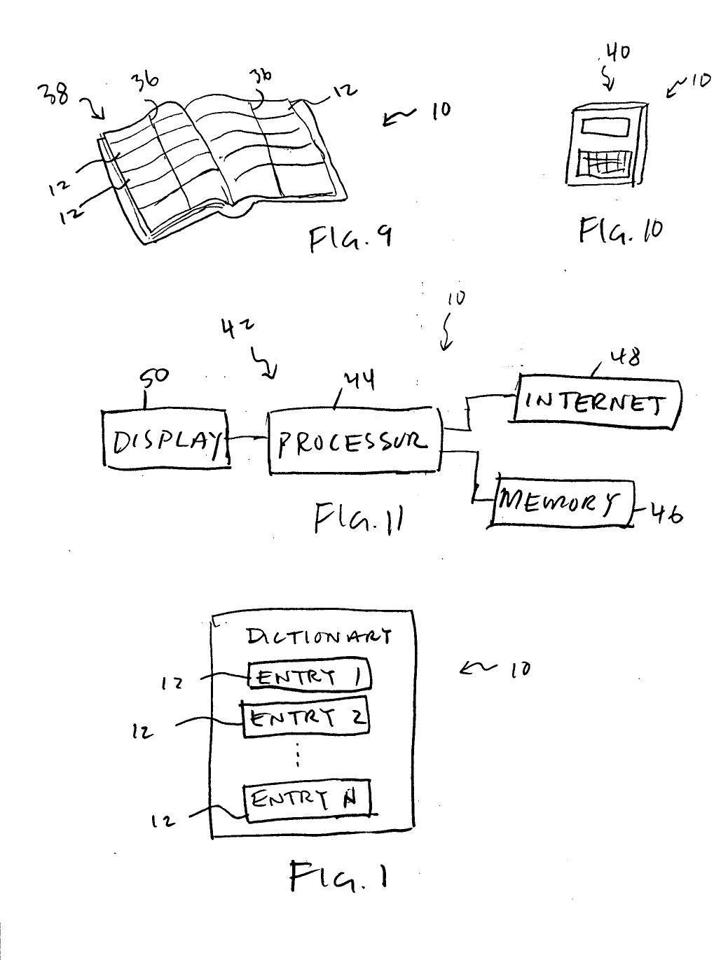

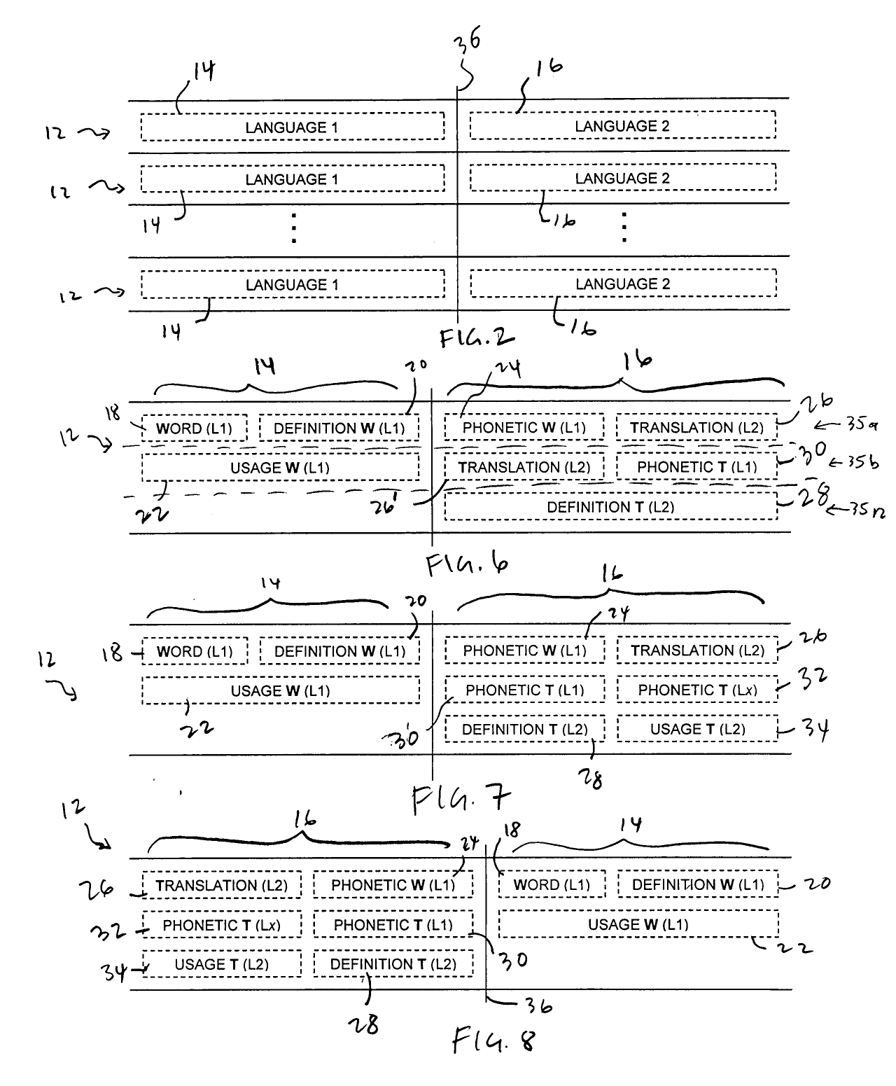

Referring particularly to FIGS. 1 and 2 of the drawings, a foreign language dictionary 10 includes a plurality of entries 12 each including a first language section 14 and a second language section 16. For example, as shown in FIGS. 3, 4, and 5, the first language of the first language section 14 is English, while the second language of the second language section 16 of FIG. 3 is Dari (a language of Afghanistan), second language of the second language section 16 of FIG. 4 is Spanish, and second language of the second language section 16 of FIG. 5 is Mandarin (traditional script).

In a number of embodiments, such as shown in FIG. 6, the first language section 14 of each entry 12 may include a target word 18 in the first language (indicated by “L1” in the drawings) and a definition 20 of the target word 18 (indicated by “W” in the drawings) in the first language, thereby providing a Language 1-to-Language 1 functionality. In still other embodiments, the first language section 14 may include a usage 22 of the target word 18 in the first language.

In addition, the second language section 16 may include a phonetic 24 of the target word 18 of the first language and a translation 26 of the target word 18 in the second language (indicated by “L2” in the drawings), thereby providing a Language 1-to-Language 2 functionality. The second language section 16 may also include a definition 28 of the translation 26 (indicated by “T” in the drawings) in the second language, thereby providing a Language 2-to-Language 2 functionality. In still other embodiments, the second language section 16 may also include a phonetic 30 of the translation 26 in the first language. In other embodiments, such as shown in FIG. 7, the second language section 16 may further include an auxiliary phonetic 32 of the translation 26 in another language or in a particular phonetic system; for example, if the second language is Mandarin, the auxiliary phonetic 32 may utilize a Roman phonetic system such as pinyin or one of the non-Roman phonetic systems used in Chinese-speaking nations. And in other embodiments, the second language section 16 may include a usage 34 of the translation 26 in the second language.

The translation 26 in the second language may include a single-word translation or, alternatively, a multi-word translation. For example, if the target word 18 is the English word friend, then if the second language is Spanish, the translation 26 may include a single-word translation of amiga or a multi-word translation 26 of amiga, camarada.

As shown in the embodiment in FIG. 6, each entry 12 may include a plurality of lateral lines, which are shown separated by dashed lines in the drawings and generally indicated by reference numeral 35 and specifically indicated by 35a, 35b, . . . , 35n. In a number of embodiments, the second language section 16 may include a second instance of the translation, which is indicated by reference numeral 26′. For example, the first instance of the translation 26 may be included in a first lateral line 35a, and the second instance of the translation 26′ may be included in the second lateral line 36b.

Accordingly, in a number of embodiments as shown in the embodiments of FIGS. 3, 4, and 5, the first lateral line 35a of the first language section 14 may include the target word 18 positioned adjacent to the definition 20 of the target word 18 in the first language, thereby providing the Language 1-to-Language 1 functionality in the same lateral line 35a (with the second lateral line 35b of the first language section 14 including the usage 22). In addition, the first lateral line 35a of the second language section 16 may include the phonetic 24 positioned adjacent to the first instance of the translation 26, thereby providing the Language 1-to-Language 2 functionality in the same first lateral line 35a. Further, the second lateral line 35b of the second language section 16 may include the second instance of the translation 26′ positioned adjacent to phonetic 30 which, in turn, is positioned adjacent to definition 28, thereby providing the Language 2-to-Language 2 functionality in the same lateral line 35b. Such a single-line relationship in the multiple functionalities enhances the familiarity and ease of use of the dictionary 10.

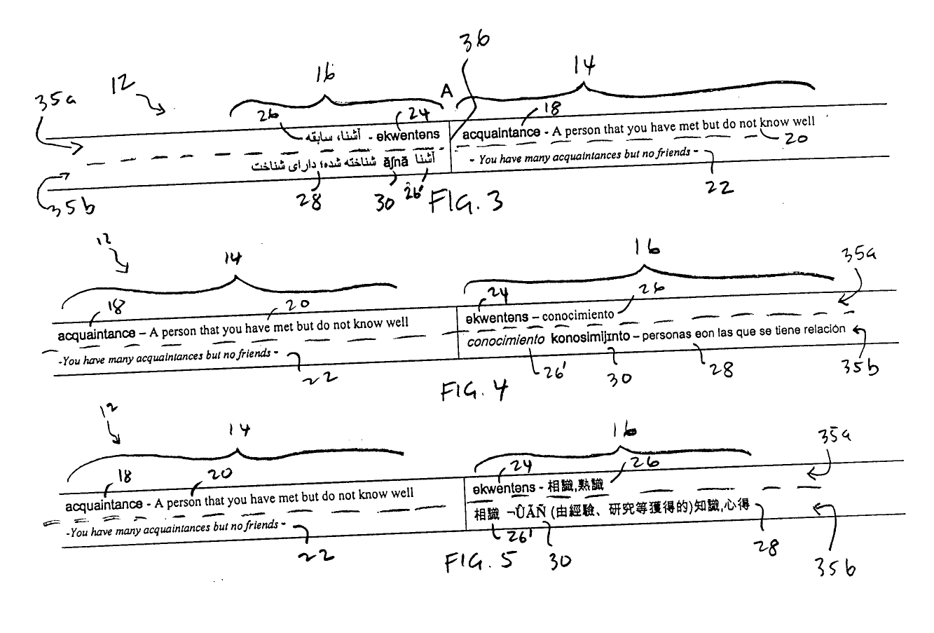

As shown in FIGS. 2-7, the language sections 14, 16 of the entries 12 may be disposed laterally with respect to each other, with a longitudinal separator 36 (see, e.g., FIGS. 2 and 3) laterally dividing the language sections 14, 16. Accordingly, in a number of embodiments, the target word 18 of the first language section 14 may be disposed adjacent to the separator 36 as shown in FIGS. 3 and 8, with the phonetic 24 of the target word 18 in the second language section 16 being adjacent to the separator 36.

This feature has particular utility in embodiments in which the first language section 14 includes a Roman or a Cyrillic language that is written left to right, such English, Spanish, and Russian, and in which the second language section 16 includes a language that can be written right to left, such as Arabic, Dari, Mandarin, and Japanese. Accordingly, the first language section 14 with the target word 18 disposed on the right side of the separator 36 enables a user to read the first language section 14 normally (i.e., left to right), and the second language section 16 with the phonetic 24 on the left side of the separator 36 enables a user to read the second language section 16 normally (i.e., right to left).

With reference to FIG. 9, the dictionary 10 may be in the form of a book 38. Alternatively, as shown in FIG. 10, the dictionary 10 may be in the form of an electronic dictionary 40. In still other embodiments, such as shown in FIG. 11, the dictionary 10 may be in the form of a computerized dictionary in which a computer 42 with a processor 44 may retrieve entries 12 from memory 46 or the Internet 48 for output on a display 50. If the entries 12 are retrieved from memory 46, then the dictionary 10 is in the form of a software dictionary (e.g., stored on a hard drive, CD-ROM, and so on). If the entries are retrieved from the Internet 48, then the dictionary 10 is in the form of an online dictionary.

Those skilled in the art will understand that the preceding embodiments of the present invention provide the foundation for numerous alternatives and modifications thereto. These other modifications are also within the scope of the present invention. Accordingly, the present invention is not limited to that precisely as shown and described in the present invention.

1. A foreign language dictionary comprising:
a plurality of entries each including a first language section and a second language section;
the first language section including:
a target word in the first language; and
a definition of the target word in the first language; and
the second language section including:
a translation of the target word in the second language; and
a definition of the translation in the second language.

2. The dictionary of claim 1 wherein the second language section further includes a phonetic of the target word of the first language.

3. The dictionary of claim 2 wherein the first language section further includes a usage of the target word in the first language.

4. The dictionary of claim 2 wherein the second language section further includes a phonetic of the translation in the first language.

5. The dictionary of claim 4 wherein the second language section further includes an auxiliary phonetic of the translation.

6. The dictionary of claim 2 wherein the second language section further includes a usage of the translation in the second language.

7. The dictionary of claim 2 wherein the language sections of each of the entries are disposed laterally with respect to each other.

8. The dictionary of claim 7 wherein each of the entries includes a longitudinal separator for laterally dividing the language sections.

9. The dictionary of claim 8 wherein the target word of the first language section is disposed adjacent to the separator, and the phonetic of the target word in the first language of the second language section is adjacent to the separator.

10. The dictionary of claim 9 wherein the first language section includes a right-to-left language, and the second language section includes a left-to-right language.

11. The dictionary of claim 10 wherein the target word is disposed on a right side of the separator, and the phonetic of the translation is disposed on a left side of the separator.

12. The dictionary of claim 1 wherein each of the entries includes a plurality of lateral lines.

13. The dictionary of claim 12 wherein a first lateral line of each of the first language sections includes the target word positioned next to the definition of the target word in the first language.

14. The dictionary of claim 13 wherein a first lateral line of each of the second language sections includes the translation of the target word.

15. The dictionary of claim 14 wherein the first lateral line of each of the first language sections is the same lateral line as the first lateral line of each of the second language sections.

16. The dictionary of claim 15 wherein a second lateral line of each of the second language sections includes a second instance of the translation positioned next to the definition of the translation in the second language.

17. The dictionary of claim 1 wherein the dictionary is a book.

18. The dictionary of claim 1 wherein the dictionary is an electronic dictionary.

19. The dictionary of claim 1 wherein the dictionary is a software dictionary.

20. The dictionary of claim 1 wherein the dictionary is an online dictionary.
